(19) United States
(12) Patent Application Publication
(10) Pub. No.: US 2019/0128444 A1
(43) Pub. Date: May 2, 2019

(54) PACKING SEAL FOR FLUID REGULATING DEVICE

(71) Applicant: A.W. CHESTERTON COMPANY, Groveland, MA (US)

(72) Inventor: Heath Lawrence GUNDERMAN, Peabody, MA (US)

(21) Appl. No.: 15/801,798

(22) Filed: Nov. 2, 2017

(51) Int. Cl. F16K 41/02; D02J 3/18; D06B 9/00

(52) U.S. Cl. CPC F16K 41/02; D06B 9/00; D02J 3/18

(57) ABSTRACT

A packing material suitable for use with a fluid regulating device comprising a main body having a yarn material formed into a selected shape and treated with a boron nitride material.

### FIELD OF THE INVENTION

The present invention relates to a packing material for use with a fluid regulating device, and more particularly relates to a packing material that helps significantly reduce the level of emissions accidentally escaping from the fluid regulating device.

### BACKGROUND OF THE INVENTION

There exists in the art many different types of fluid regulating devices, including valves, regulators, differential pressure transducers and the like. Conventional fluid regulating devices, such as valves, are used in many different types of commercial applications to help regulate the flow of a fluid through a fluid conveyance system. Conventional valves come in many different shapes and sizes, and can include for example block or gate valves, control valves and the like. When used in commercial applications, the valves typically employ a mechanical packing material to help reduce fluid loss and the amount of unwanted gaseous emissions, such as volatile organic compounds (VOCs) that leak or are accidentally emitted from the valve. These types of emissions are called fugitive emissions.

As is known, volatile organic compounds are organic compounds that have a high vapor pressure at ordinary or room temperature. VOCs can either be human-made and are naturally occurring as well, and can include many different types of compounds. Some of these compounds, such as those that are released at commercial installations, can be hazardous to humans and to the environment. According to the Environmental Protection Agency (EPA), volatile organic compounds can cause headaches, loss of coordination, nausea, liver and kidney damage, irritation to the nose and throat, and potentially cancer in selected people.

One of the largest sources of VOC emissions in the United States are valves used in industrial and commercial installations. Current regulations require that the valves be checked annually for emissions. In the valves, the component used therein that is most susceptible to degradation over time and hence allow VOC emissions is the mechanical packing material. Conventional packing material suffers volume loss and gradual wear over time which impacts its overall sealing abilities. Further, in high temperature applications, such as applications where the valves control fluid higher than 500° F. (or 260° C.), the combination of age and temperature serve to degrade conventional packing material over time. Thus, PTFE based packing materials lose their ability to seal at high temperatures. This typically occurs since conventional packing materials use polytetrafluoroethylene (PTFE), which degrades or thermally decomposes at high temperatures. As such, there is currently no mechanical packing material on the market suitable for use in high temperature applications that can reduce fugitive emissions below acceptable levels, such as below 100 ppm.

### SUMMARY OF THE INVENTION

It is therefore an object of the present invention to provide a packing material suitable for use in low and high temperature environments and which reduce fugitive emissions below 100 ppm.

In an effort to address the issue of fugitive emissions in valves operated in high temperature environments, the present invention is directed to a packing material suitable for use in these environments. Hence, the present invention is directed to a low fugitive emission packing material that can be used in low and high temperature environments.

According to one practice of the present invention, a packing material suitable for use with a fluid regulating device is provided that has a main body having a yarn material formed into a selected shape and treated with a boron nitride material. The main body of the packing material can include a core element.

The main body can also have a square braid pattern and can comprise a core element, an outer jacket disposed about the core element, and a plurality of corner elements disposed at each corner of the square braid main body. The core element can be formed from a carbon fiber yarn, and the outer jacket can be formed from a graphite tape yarn. Further, according to one embodiment, each of the plurality of corner elements is formed from a graphite tape yarn.

The present invention is also directed to a method of forming a low emission, high temperature packing material comprising providing a yarn material, coating the yarn material with a high temperature coating solution to form a coated yarn, wherein the high temperature coating solution includes boron nitride, and drying the coated yarn.

The high temperature solution can include 55%-75% boron nitride and 45%-25% water. Alternatively, the high temperature solution can include 60%-70% boron nitride and 40%-30% water, and more preferably the high temperature solution includes 63% boron nitride and 37% water.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic cross-sectional view of a conventional valve component mounting the packing material according to the teachings of the present invention.

FIG. 2 is a cross-sectional view of an exemplary square braid packing material employing boron nitride according to the teachings of the present invention.

FIG. 3 is a schematic flow chart diagram illustrating the steps involved in applying a high temperature material, such as boron nitride, to a packing yarn using a wet braiding technique according to the teachings of the present invention.

### DETAILED DESCRIPTION

The present invention is directed to a mechanical packing material suitable for use with a fluid regulating device for reducing or minimizing the amount of fugitive emissions emitted or leaking from the fluid regulating device. As used herein, the term “fluid regulating device” is intended to encompass any selected device that helps, assists, prevents, or regulates the flow of a fluid through a fluid transport or conveyance medium, such as a pipe. The fluid regulating device is preferably of a type that employs a packing material, and can include valves, regulators, and the like. When a valve is employed, the valves can have any selected size and shape, and can include for example a hydraulic valve, a manual valve, a pneumatic valve, a solenoid valve, or a motor valve. Types of valves that are suitable for use with the present invention can include a block valve including a gate, butterfly, ball and plug valves, a control valve, or a check valve including quarter turn and globe valves. Those of ordinary skill will readily recognize that the packing material of the present invention can also be used with mechanical seals.

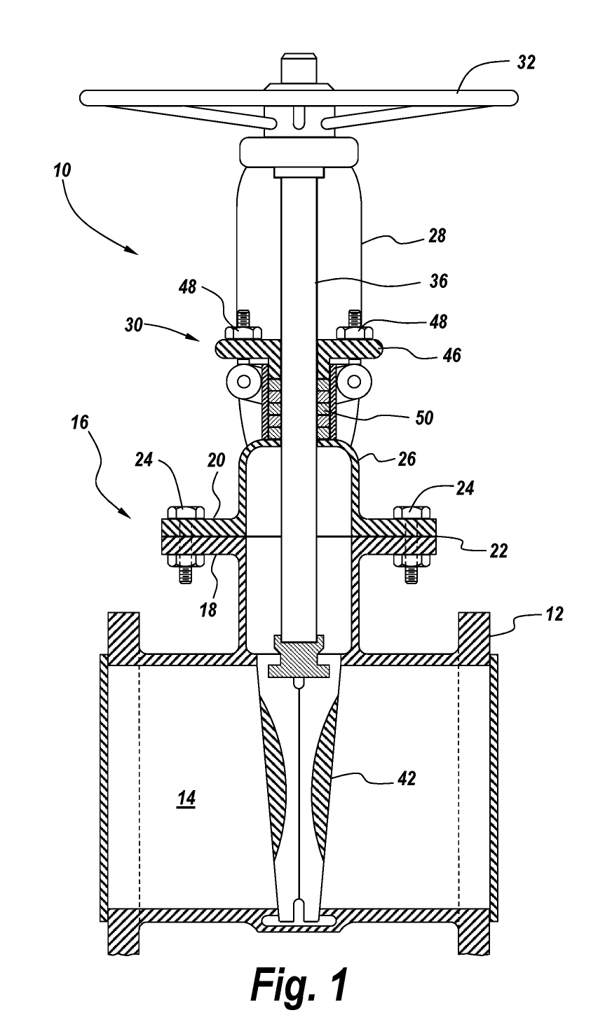

FIG. 1 is a schematic view of an exemplary fluid regulating device, such as a block valve 10, that employs the packing material of the present invention. Those of ordinary skill in the art will readily recognize that the block valve illustrated herein is only one type of fluid regulating device that can be used with the present invention, and that other type of valves can also be used. The block valve is shown for purposes of illustration and for the sake of simplicity. The illustrated block valve 10 includes a body portion 12 that has an opening or chamber 14 formed therein. Each end of the body 12 is adapted to be coupled to a fluid pipe that carries the fluid to be regulated by the valve 10. The body 12 is coupled to a bonnet portion 16. The bonnet portion 16 is typically formed of a first bonnet portion 18 that is coupled to the body 12 and a second bonnet portion 20 that is coupled to the remainder of the valve, including the integrally formed bonnet bushing 26. A gasket 22 is mounted between the first and second bonnet portions, which are then secured together via suitable fasteners, such as the illustrated bolt and nut assemblies 24, 24. The bonnet bushing 26 is coupled to a yoke portion 28 via a gland and flange portion 30. The yoke 28 is then coupled to a handwheel 32. Typically, the gland and flange portion can comprise flange and gland nose elements that are independent elements of the bonnet and yoke of the valve 10. The yoke 28 can be cast or formed as part of the bonnet assembly to support the valve stem and thrust bearing. As such, the gland and flange portion 30 can be removable sub-sections of the bonnet bushing 26 connected by the gland bolts 48.

The illustrated handwheel 32 is coupled to one end of a vertically movable valve stem 36. The handwheel when rotated serves to move the valve stem 36 upwards and downwards in a vertical directions depending upon the direction of rotation of the wheel. The valve stem 36 is coupled at the other end to a valve wedge assembly 42 that is disposed in the chamber 14. The valve wedge assembly 42 serves to regulate the flow of fluid passing through the body 12 depending upon the position of the assembly 42 within the chamber 14, as is known in the art. The gland and flange portion 30 can include a flange or gland element 46 that seats against a packing material 50 that is mounted therein. The gland element 46 can be moved in the vertical direction by tightening the gland bolts 48, 48. When the gland bolts are tightened, the packing seal or material 50 is further compressed by the gland element 46, as is known in the art. The packing seal 50 is intended to form a fluid tight seal with the valve stem 36. The packing seal 50 can be composed of a series of axially abutting packing rings, which are wrapped around the valve stem shaft and provides an interface and dynamic sealing surface between the shaft and the remainder of the fluid regulating device.

Over time, the packing material 50 tends to decompose and lose volume, thus allowing emissions, such as volatile organic compounds, to escape the valve. In order to address the unwanted loss of volume and hence the increase in fugitive emissions, the operator of the valve can typically compress the packing further via the gland bolts 48, 48. Those of ordinary skill in the art will readily recognize, however, that the packing material can only be compressed to a selected degree and a selected number of times in an effort to prevent the escape of fugitive emissions. Further, in high temperature environments (e.g., temperatures above 500° F.), the packing material breaks down and the fluid sealing capabilities decrease, thus allowing the loss of fugitive emissions.

In an effort to address the issue of fugitive emissions in fluid regulating devices, such as valves, operated in high temperature environments, the present invention is directed to a packing material 50 suitable for use in these environments. Hence, the present invention is directed to a low fugitive emission packing material that can be used in low and high temperature environments. As used herein, the term “low emission” is intended to mean the loss or escape of emissions from the fluid regulating device below about 100 ppm, and preferably below about 75 ppm, and more preferably below about 50 ppm.

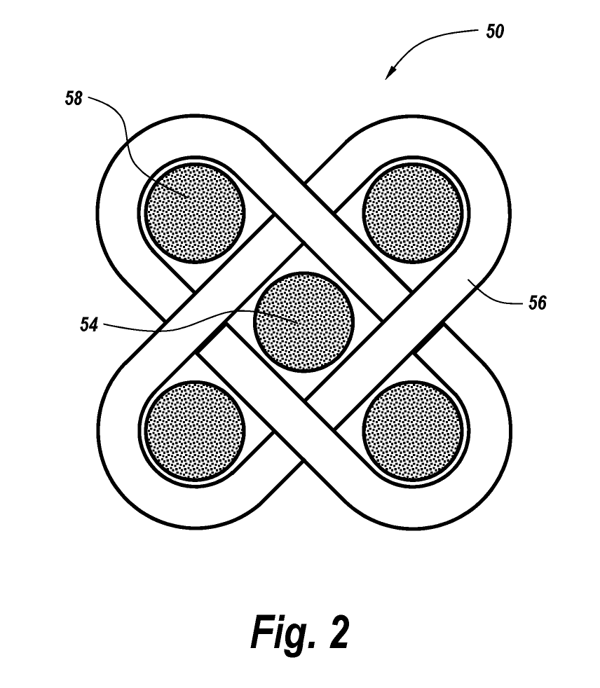

The packing material 50 of the present invention can have any selected shape and size, and can be formed in an interbraid pattern or a square braid pattern, or any other suitable braiding pattern known to those of ordinary skill in the art. The compression packing seal 50 may be in the form of a braided material that is commonly square or round when viewed in cross section, although the compression packing seal 50 may be provided in a variety of cross-sectional shapes. The compression packing seal 50 may be cut to an appropriate size and wrapped around the shaft of the valve stem to form a ring. Multiple rings may be provided along the length of the shaft 36 in order to provide a seal around the shaft. Although the present invention can be employed with any suitable type and shape of packing material, for the sake of simplicity a square braid pattern as shown in FIG. 2 is shown and described. As known in the art, a square braid is formed by braiding multiple yarns, typically of the same type of material, along a set of material paths. One of ordinary skill in the art will readily recognize that the packing material can be formed from multiple different types of materials, and can be braided in a symmetrical or asymmetrical manner relative to a lateral or horizontal axis across a cross-sectional face of the packing material. The packing material can be selected for specific applications and to exhibit selected properties, as is known in the art. Examples of various types of braids and braiding patterns are shown in U.S. Pat. No. 9,388,903, the contents of which are herein incorporated by reference.

The illustrated packing material 50 can have a main body having an optional central core 54 that can be formed from any suitable material. According to one embodiment, the central core 54 can have any selected shape and size and can be formed from a continuous carbon fiber yarn that preferably has wide temperature capabilities, including high temperature capabilities, and a relatively or generally smooth surface area. The core 54 is relatively resilient such that it has a selected degree of compressibility. The characteristics of the packing core are such that the core can function similar to an internally located spring element so that the packing material via the core can recover while in service. The core 54 can be formed from any suitable yarn material, including acrylic, rayon, fiberglass, carbon, graphite, flax, jute, ramie, cotton, aramid, polyphenylene sulfide (PPS), polyimide fiber (PI), polybenzimidazole fiber (PBI), melamine fiber, ceramic, glass, novoloid fibers, polytetrafluoroethylene fibers (PTFE), and expanded polytetrafluoroethylene/graphite composite fibers.

The main body of the packing material 50 also includes an outer jacket 56 that can be formed from a suitable yarn material that is optionally encapsulated in a wire mesh material. The mesh material can be formed from copper, brass, lead, Inconel, stainless steel, or monel materials. The packing material 50 can also optionally include at each respective corner of the braid a corner yarn material that can be formed from a graphite tape yarn 58 that is optionally encapsulated in a wire mesh material. The jacket and corner yarn can be formed from any selected yarn material, such as graphite, acrylic, rayon, fiberglass, carbon, flax, jute, ramie, cotton, aramid, polyphenylene sulfide fiber (PPS), polyimide fiber (PI), polybenzimidazole fiber (PBI), melamine fiber, ceramic, glass, novoloid fibers, polytetrafluoroethylene fibers (PTFE), and expanded polytetrafluoroethylene/graphite composite fibers. Those of ordinary skill in the art will readily understand how the square braid can be formed using conventional packing braiding machines.

The packing material 50 can be treated or coated during the braiding or packing forming process with a selected material that is suitable for high temperature environments. According to the teachings of the present invention, the packing material can be treated with a suitable high temperature material, such as boron nitride (BN), according to a wet braiding technique. The chemical forms of BN can include amorphous, hexagonal, cubic, and wurtzite. The preferred form for this specific application is hexagonal due to the tightness and strength a hexagonal shape creates when bonded to another, which ultimately assists in the overall fluid barrier/blocking capabilities of the coating. The treatment or coating of the packing material with the high temperature material during formation permits the packing material to be used in high temperature environments. When treated as such, the packing material need not be treated with or include a PTFE material, and hence can be, if desired, PTFE free or contain none or merely nominal amounts of PTFE. For low temperature environments (e.g., temperatures below 500° F.), then the packing material can also employ BN and can also include, if desired, PTFE in addition to the boron nitride. Those of ordinary skill in the art will also recognize that boron nitride is suitable for operation in low temperature environments in addition to high temperature environments, thus providing a coating for the packing material suitable for use in a wide range of low and high temperatures.

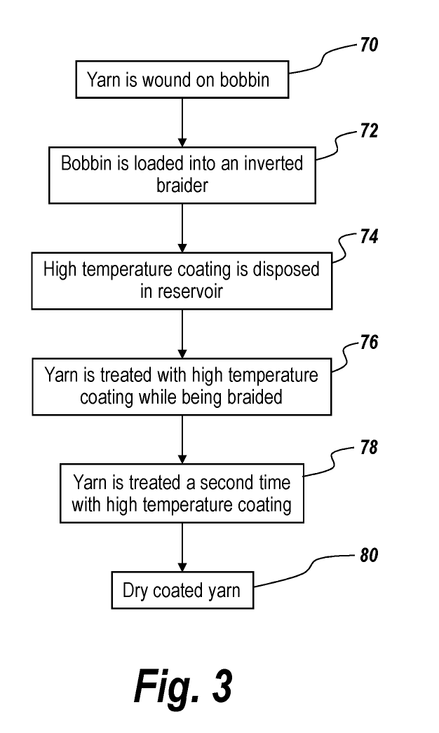

According to one embodiment of the present invention, the yarn forming any selected portion of the packing material 50, and specifically the yarn forming the outer jacket 56 of the packing material 50, can be treated or coated with the high temperature material according to a wet braiding technique. The wet braiding technique allows the treatment or coating to penetrate the yarn material during the braiding or formation process, thus forming an effective seal or barrier against fugitive emissions. FIG. 3 is a schematic flow chart diagram illustrating a wet braiding and coating technique for coating a selected portion of the packing material with the high temperature material. For the sake of simplicity, the outer jacket can be treated with the high temperature material and is described below. The yarn forming the outer jacket 56 of the packing material 50 is initially wound on a conventional bobbin, step 70, and then the bobbin once loaded with the yarn is inserted into a braiding machine, such as an inverted braider machine, step 72. A coating or treating solution that includes the high temperature material is placed in a receptacle or reservoir, step 74. The coating solution can include according to one embodiment of the invention a mixture of boron nitride and water in selected amounts. The boron nitride in the solution or mixture can be between about 55%-75% by weight and the water in the solution or mixture can be between about 45%-25% by weight. According to a preferred embodiment, the BN is between about 60%-70% by weight and the water is between about 40%-30% by weight, and most preferably the BN is about 63% by weight and the water is about 37% by weight of the solution. Other material can be added to the solution in addition to the BN and water if so desired.

The yarn is treated or coated with the high temperature solution while being braided, step 76. The once coated yarn can then be optionally passed through the coating solution a second time, step 78. The coated yarn is then dried, step 80, according to known techniques, such as by open air ovens and the like. The coated and dried yarn can then be pressed if desired to meet dimensional specifications for cross-section and height. The coated yarn can then be wound on a spool for storage.

The packing material 50 treated with the high temperature coating material reduces fugitive emissions that escape from a fluid regulating device below about 100 ppm over the useful life of the packing material, and hence is compatible with the ISO 15848-1 and ISO 15848-2 international standards.

The present invention also contemplates the use of a non-braided packing material, or a packing material that has braided and non-braided components. The high temperature material can be added to any selected type of packing material, which in turn can have any selected shape or size. For example, once the packing material is treated with the high temperature material, the packing material can be shaped, such as by molding, into any selected geometry and size.

The invention is described herein relative to illustrated embodiments. Those skilled in the art will appreciate that the present invention may be implemented in a number of different applications and embodiments and is not specifically limited in its application to the particular embodiment depicted herein.

The terms “axial” and “axially” used herein refer to a direction generally parallel to the axis of a shaft. The terms “radial” and “radially” used herein refer to a direction generally perpendicular to the axis of a shaft. The terms “fluid” and “fluids” refer to liquids, gases, and combinations thereof.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and desired to be secured by Letters Patent is:

1. A packing material suitable for use with a fluid regulating device, comprising a main body having a yarn material formed into a selected shape and treated with a boron nitride material.

2. The packing material of claim 1, wherein the main body has a core element.

3. The packing material of claim 1, wherein the main body has a square braid pattern and comprises a core element, an outer jacket disposed about the core element, and a plurality of corner elements disposed at each corner of the square braid main body.

4. The packing material of claim 3, wherein the core element is formed from a carbon fiber yarn.

5. The packing material of claim 3, wherein the outer jacket is formed from a graphite tape yarn.

6. The packing material of claim 3, wherein each of the plurality of corner elements is formed from a graphite tape yarn.

7. A method of forming a low emission, high temperature packing material, comprising
providing a yarn material,
coating the yarn material with a high temperature coating solution to form a coated yarn, wherein the high temperature coating solution includes boron nitride, and
drying the coated yarn.

8. The method of claim 7, wherein the high temperature solution includes 55%-75% boron nitride and 45%-25% water.

9. The method of claim 7, wherein the high temperature solution includes 60%-70% boron nitride and 40%-30% water.

10. The method of claim 7, wherein the high temperature solution includes 63% boron nitride and 37% water.
